(19) United States
(12) Patent Application Publication
(10) Pub. No.: US 2006/0101020 A1
(43) Pub. Date: May 11, 2006

(54) Systems, methods, and computer program products for scheduled shared resource security

(76) Inventor: Jeffrey A. Aaron, Atlanta, GA (US)

Correspondence Address: MYERS BIGEL SIBLEY & SAJOVEC, P.A., P.O. BOX 37428, RALEIGH, NC, 27627, US

(21) Appl. No.: 10/982,484

(22) Filed: Nov. 5, 2004

(51) Int. Cl. G06F 17/30; G06F 7/00

(52) U.S. Cl. 707/9

(57) ABSTRACT

A system for managing security for a shared resource, e.g., a conference room, office, lab or other premises, includes a reservation-based scheduler configured to accept user requests from multiple users for reservation of the resource and that responsively generates a usage schedule for the resource. The system further includes a security controller, operatively associated with the scheduler, that manages security of the resource responsive to the generated usage schedule. The scheduler may be configured to associate a security configuration with tie usage schedule, and the security controller may manage security of the resource responsive to the usage schedule and the associated security configuration.

### FIELD OF THE INVENTION

The present invention relates to security systems, methods and computer program products, and, more particularly, to methods, systems, and computer program products for managing security of shared resources.

### BACKGROUND OF THE INVENTION

Many organizations, such as businesses and government agencies, have resources, such as premises, vehicles, and equipment, which may be shared by multiple users. A computer-implemented scheduling application, such as Microsoft® Outlook®, may be used to manage such resources. For example, using such a scheduling program, a user may “reserve” a resource by creating a calendar entry that indicates to other users the availability of a resource. Thus, for example, when a user wishes to create a meeting using Outlook®, she can identify the potential attendees for the meeting, along with a conference room, audiovisual equipment, and other resources that will be used for the meeting. If another user wishes to subsequently create another meeting using all or some of the resources, Outlook® will inform her of the restrictions on those resources for the time period assigned to the previously created meeting. Although such computer-based applications are generally helpful in efficiently scheduling use of shared resources, there is an ongoing need for improved techniques for managing shared resources.

### SUMMARY OF THE INVENTION

According to some embodiments of the present invention, a system for managing security for a shared resource, e.g., a conference room, office, lab or other premises, includes a reservation-based scheduler configured to accept user requests from multiple users for reservation of the resource and to responsively generate a usage schedule for the resource. The system further includes a security controller, operatively associated with the scheduler, that manages security of the resource responsive to the generated usage schedule. The scheduler may be configured to associate a security configuration with the usage schedule, and the security controller may manage security of the resource responsive to the usage schedule and the associated security configuration.

In further embodiments, the scheduler is configured to identify the security configuration responsive to a user request. For example, the security controller may be operative to modify the security configuration responsive to an input from a security device at the premises or other shared resource. The security controller may be operative to interact with an access control device, a user input device, a security sensor, a security indicator and/or a security alarm based on the generated usage schedule. The security controller may, for example, impede unauthorized access to the premises responsive to the usage schedule and/or cause an indicator at the premises to provide an indication of a presence of an unauthorized party responsive to the usage schedule.

According to some computer-implemented method embodiments of the present invention, security of a shared resource is managed by accepting user requests from multiple users for reservation of the resource, responsively generating a usage schedule for the resource and managing security of the resource responsive to the generated usage schedule. A security configuration may be associated with the usage schedule, and managing security of the resource responsive to the generated usage schedule may include managing security of the resource responsive to the usage schedule and the associated security configuration.

In still further embodiments of the present invention, computer program products for managing security of premises are provided. In some embodiments, a computer program product includes computer readable program code embodied in a computer readable storage medium, the computer readable program code including code configured to accept user requests for reservation of the premises and to arbitrate the user requests to generate a usage schedule for the premises. The computer readable program code further includes code configured to manage security at the premises based on the generated usage schedule.

### BRIEF DESCRIPTION OF THE DRAWINGS

FIG. 1 is a schematic diagram illustrating reservation-based security for building premises according to some exemplary embodiments of the present invention.

FIG. 2 is a schematic diagram illustrating a system for providing reservation-based security according to further embodiments of the present invention.

FIGS. 3-6 are flowcharts illustrating exemplary security management operations for a shared resource according to additional embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Some embodiments of the present invention arise from a realization that, while scheduling applications, such as Outlook®, can manage information relating to shared resources, improved management of shared resources may be achieved by marrying a reservation-based scheduling system with security functions that are adaptive to the reservations created by the scheduling system. For example, in some exemplary embodiments of the present invention, premises, such as conference rooms, auditoriums, offices, laboratories and the like, may be managed by controlling access and/or monitoring features, such as access-control devices, motion detectors, and video surveillance equipment, based on reservations generated by a scheduling application. The reservation information may be used, for example, to deter unauthorized parties, such as “squatters,” from using the premises, and/or to detect the presence of unauthorized parties i.e., potential eavesdroppers, to enable authorized users to protect confidential information. In other embodiments, such techniques may be applied to non-premises resources, such as vehicles and/or equipment.

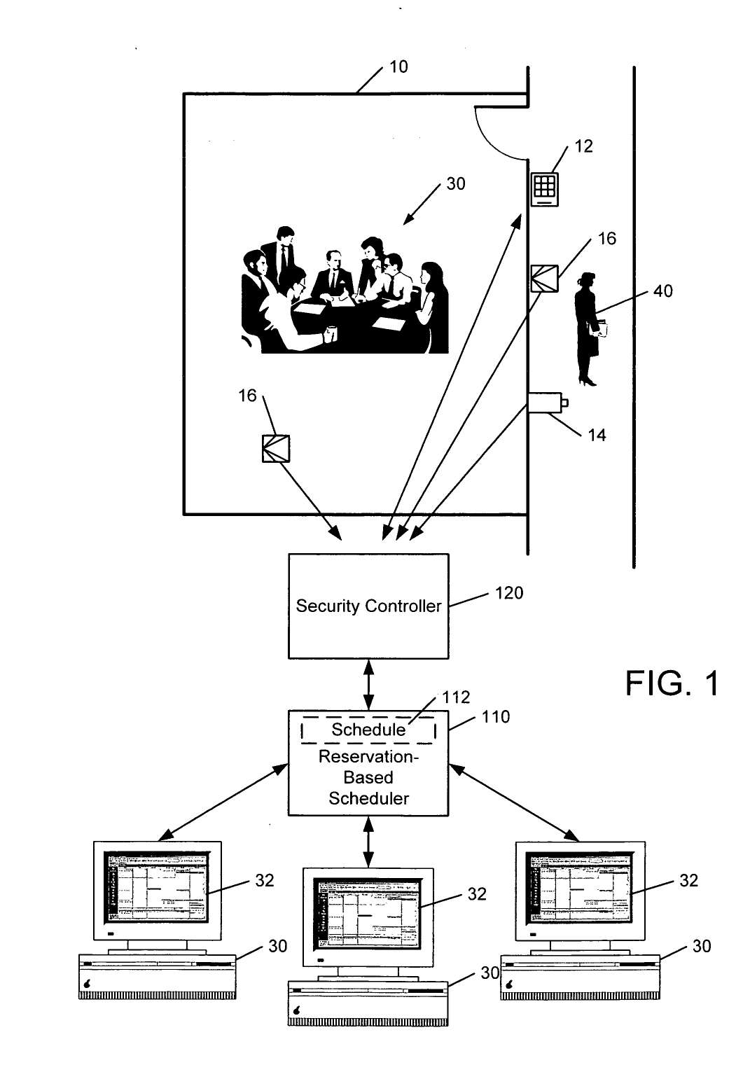

FIG. 1 illustrates an exemplary implementation of shared resource management system 100 and related methods according to some embodiments of the present invention. A shared resource management system 100 includes a reservation-based scheduler 110 that is configured to receive and arbitrate requests for reservation of a shared resource, in this example, a conference room 10. As shown, the scheduler 110 is configured to support calendar interfaces 32 at user terminals 30. The calendar interfaces 32 are configured to convey reservation requests from users at the terminals 20 and to convey them to the scheduler 110, which responsively generates a resource usage schedule 122. The scheduler 110 also supports display of schedule-related information as part of the arbitration process (e.g., resource availability) by the calendar interfaces 32.

The system 100 further includes a security controller 120 that is operatively associated with the scheduler 110 and with a plurality of security devices associated with the conference room 10. These security devices may include, for example, an access control device, e.g., a keypad 12, and sensors located in the room 10, such as a motion detector 16. The security devices may also include sensors, e.g., a motion detector 16 and/or a video camera 14, located in areas proximate the conference room 10, such as a nearby hallway 20 in which an unauthorized party 40, e.g., an eavesdropper, may overhear conversations or receive other information presented in the conference room 10. The security controller 120 controls the security devices 12, 14, 16 responsive to the schedule generated by the scheduler 110, such that security operations of the conference room 10 are controlled based on the schedule 112.

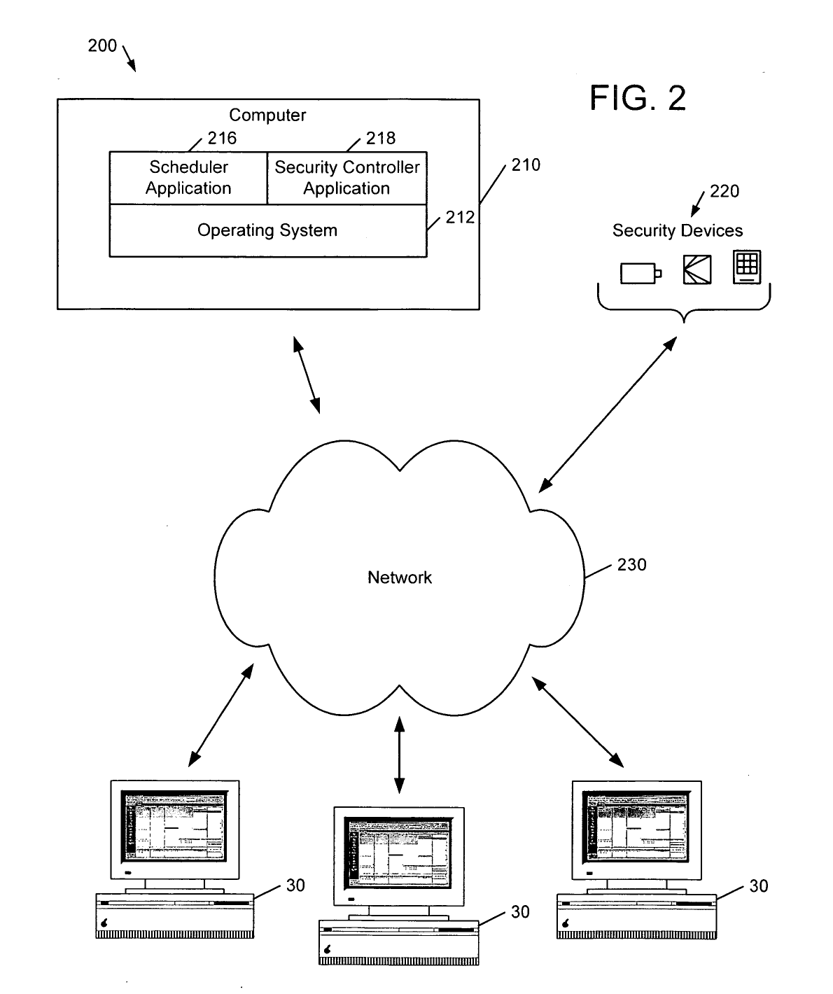

FIG. 2 illustrates an exemplary implementation of a shared resource security management system according to further embodiments of the present invention. The system 200 is implemented in a computer 210 that is configured to communicate via a network 230 with security devices 220 associated with a shared resource and with user terminals 30 that provide scheduling user interfaces. In particular, the system 200 includes scheduler and security controller applications 216, 218 that execute on an operating system 212 of the computer 210, e.g., as program code configured to support shared resource management applications such as those described above with reference to FIG. 1. It will be appreciated that the operating system 212 may provide computing, input/output, and other functions needed to support interactions of the scheduler and security controller applications 216, 218 with the security devices 220 and the terminals 30. It will be further appreciated that functions of the applications 216, 218 and the operating system 212 may be provided on a single device or distributed across multiple computing devices.

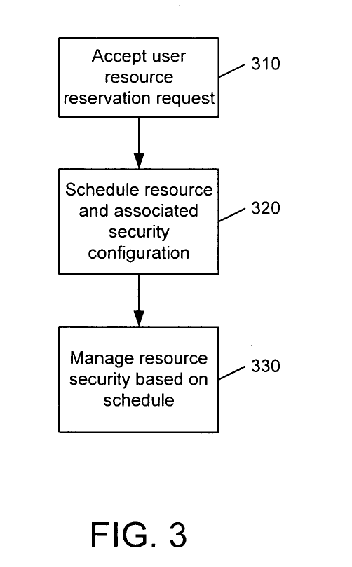

FIGS. 3-6 illustrate exemplary shared resource security management operations that may be performed by systems, such as illustrated in FIGS. 1 and 2, according to further embodiments of the present invention. Referring to FIG. 3, a user request for a reservation of a shared resource is accepted (block 310). The shared resource and an associated security configuration are scheduled (block 320). Security of the shared resource is then managed responsive to the schedule (block 330).

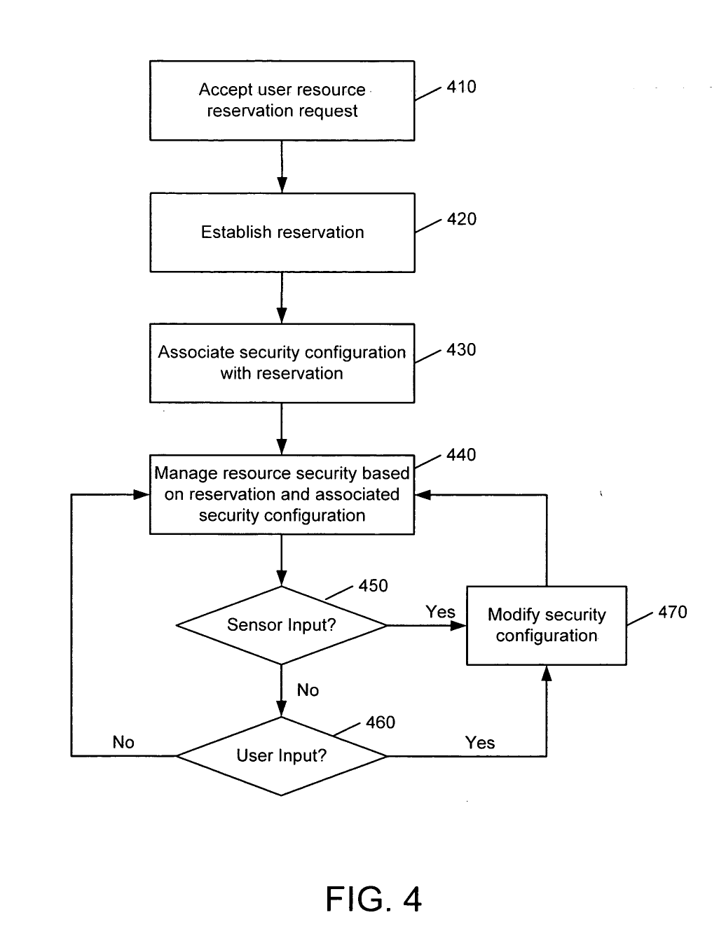

As shown in FIG. 4, security configurations can be selectively associated with shared resource reservations such that, for example, different levels of security may be provided depending on the nature of the meeting, the parties present, and the like. For example, referring to FIG. 4, a user request for a reservation of a shared resource may be accepted (block 410), and a reservation may be established responsive to the request (block 420). A security configuration may be associated with the reservation (block 430). For example, concurrent with and/or subsequent to making the reservation request, the user may make a request for a predetermined security profile, e.g., “low,” “intermediate” or “high.” The system may responsively associate the security profile with the reservation such that security devices, such as access control devices, sensors, and the like, are used in conformance with the predetermined profile. Alternatively or in combination with such techniques, the system could automatically select a security configuration from a set of predetermined configurations based on such inputs as the identity of the user requesting the reservation, the identities of parties associated with the reservation (e.g., the identities of parties invited to a meeting), and/or subject matter of the reservation (e.g., “vendor presentation,” “sales meeting”, or “legal counseling”).

Still referring to FIG. 4, security of the shared resource is managed based on the reservation and associated security configuration (block 440). As shown, the security configuration may be modified (block 470) responsive to a sensor input (block 450) and/or a user input (block 460). For example, a security sensor may detect an eavesdropper or other unauthorized party and, responsive to the detection, the system may provide visual and/or audio indications, which may enable authorized parties to initiate measures to protect confidential information. In some embodiments, the system may have event logging capabilities and a corresponding ability to modify security (e.g., enhance and/or relax particular measures) based on events detected by security sensors. For example, if the system detects an increased number of eavesdropping events for a particular location and/or at a particular time of day, the system may modify the security associated with use of a resource at particular times and/or for particular types of reservations. In some embodiments, a user may wish to modify security associated with a particular reservation after the reservation made and/or in situ. A user may, for example, wish to raise the security level of a reservation when confidential matters arise during the reserved event.

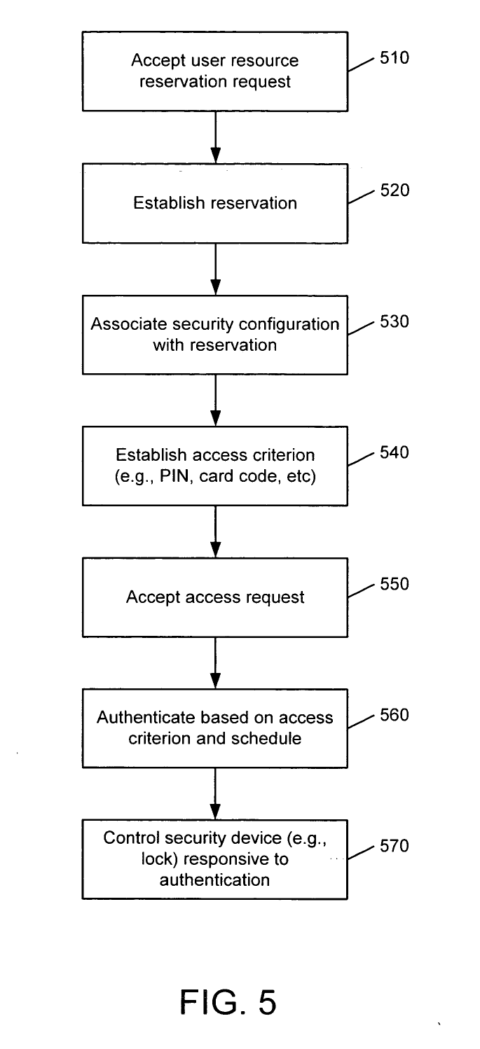

As shown in FIG. 5, access to a shared resource may be controlled based on a scheduled reservation such that, for example, “squatters” or other unauthorized parties can be deterred from using the resource. The system accepts a user request for a reservation of the shared resource (block 5-10). In response, the system establishes a reservation (block 520), and associates a security configuration with the reservation (block 530). The system also establishes an access criterion for the reservation (block 540). For example, the system may issue the user a code, e.g., a personal identification number (PIN) or alphanumeric password, and/or may enable a user badge or card to allow access to the shared resource for the time period(s) associated with the reservation. At a subsequent time, a party requests access to the shared resource, e.g., enters a PIN or password and/or swipes a card or badge (block 550). The system authenticates the access request based on the access criterion and the schedule (block 560). For example, the system may check the identity of the party requesting access and/or the validity of a code entered by the party for the particular time that the access request is entered. Responsive to the authentication, the system controls the appropriate security devices, such as a door lock, to allow or deny access (block 570).

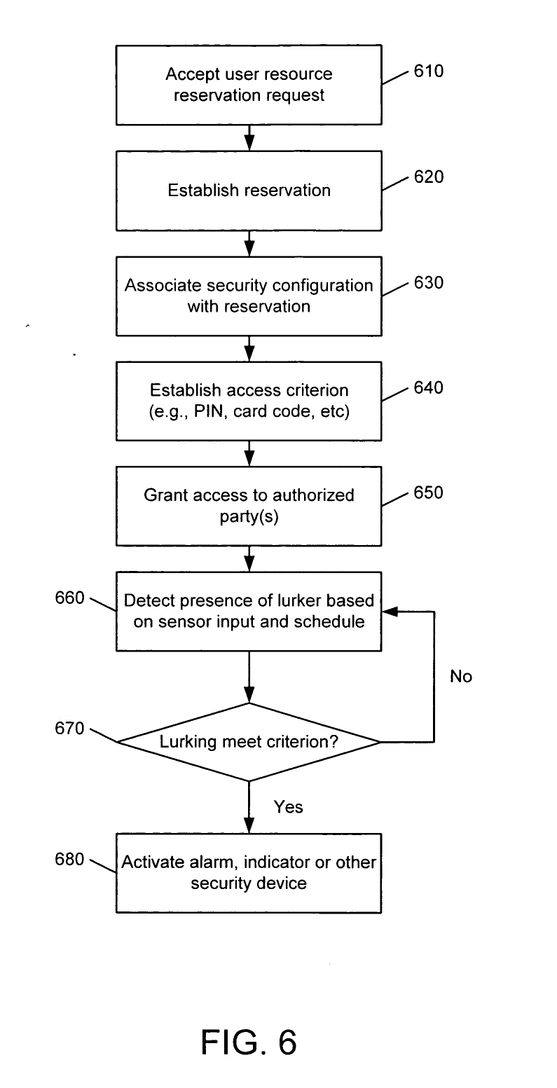

As shown in FIG. 6, the system may also provide features for warning authorized users of potential security risks based on the reservation and inputs provided by sensor devices associated with the shared resource. The system accepts a shared resource reservation request (block 610). In response, the system establishes a reservation (block 620), associates a security configuration with the reservation (block 630), and establishes an access criterion (block 640). Subsequently, the system grants access to one or more authorized parties based on the reservation and the access criterion (block 650). A lurking party, e.g., a potential eavesdropper, is detected (block 660). If the lurking meets a predetermined criterion, e.g., a time limit and/or identity criterion associated with the resource, an alarm or indicator is activated to inform the authorized party or parties of the presence of the lurking party. The authorized party or parties may then take actions, such as covering confidential documents, suspending a presentation, or the like, to prevent accidental disclosure.

The flowcharts of FIGS. 3-6 illustrate the architecture, functionality, and operations of some embodiments of methods, systems, and computer program products for managing security for a shared resource in association with a reservation-based scheduler and usage schedule, in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A system for managing security for a shared resource, the system comprising:
a reservation-based scheduler configured to accept user requests from multiple users for reservation of the resource and to responsively generate a usage schedule for the resource; and
a security controller, operatively associated with the scheduler, that manages security of the resource responsive to the generated usage schedule.

2. A system according to claim 1, wherein the scheduler is configured to associate a security configuration with the usage schedule, and wherein the security controller manages security of the resource responsive to the usage schedule and the associated security configuration.

3. A system according to claim 1, wherein the shared resource comprises premises.

4. A system according to claim 3, wherein the scheduler is configured to associate a security configuration with the usage schedule, and wherein the security controller controls the premises responsive to the usage schedule and the associated security configuration.

5. A system according to claim 4, wherein the scheduler is configured to identify the security configuration responsive to a user request.

6. A system according to claim 4, wherein the security controller is operative to modify the security configuration responsive to an input from a security device at the premises.

7. A system according to claim 3, wherein the security controller is operative to interact with an access control device, a user input device, a security sensor, a security indicator and/or a security alarm located at the premises based on the generated usage schedule.

8. A system according to claim 3, wherein the security controller is operative to impede unauthorized access to the premises responsive to the usage schedule.

9. A system according to claim 3, wherein the security controller is operative to cause an indicator at the premises to provide an indication of a presence of an unauthorized party responsive to the usage schedule.

10. A method of managing security for a shared resource, the method comprising the following acts performed by a computer:
accepting user requests from multiple users for reservation of the resource;
responsively generating a usage schedule for the resource; and
managing security of the resource responsive to the generated usage schedule.

11. A method according to claim 10, further comprising associating a security configuration with the usage schedule, and wherein managing security of the resource responsive to the generated usage schedule comprises managing security of the resource responsive to the usage schedule and the associated security configuration.

12. A method of according to claim 10, wherein the shared resource comprises premises.

13. A method according to claim 12, further comprising associating a security configuration with the usage schedule, and wherein managing security at the premises comprises managing security at the premises responsive to the usage schedule and the associated security configuration.

14. A method according to claim 13, further comprising identifying the security configuration responsive to a user request.

15. A method according to claim 12, wherein managing security at the premises comprises interacting with an access control device, a user input device, a security sensor, a security indicator and/or a security alarm located at the premises based on the generated usage schedule.

16. A computer program product for managing security of a shared resource, the computer program- product comprising computer readable program code embodied in a computer readable storage medium, the computer readable program code comprising:
code configured to accept user requests from multiple users for reservation of the resource and to responsively generate a usage schedule for the resource; and
code configured to manage security of the resource responsive to the generated usage schedule.

17. A computer program according to claim 16, wherein the computer readable program code further comprises code configured to associate a security configuration with the usage schedule, and wherein the code configured to manage security of the resource responsive to the generated usage schedule is configured to manage security of the resource responsive to the usage schedule and the associated security configuration.

18. A computer program product according to claim 16, wherein the shared resource comprises premises.

19. A computer program product according to claim 18, wherein the code configured to manage security of the resource responsive to the generated usage schedule comprises code configured to interact with an access control device, a user input device, a security sensor, a security indicator and/or a security alarm located at the premises based on the generated usage schedule.
